(19) United States
(12) Patent Application Publication
(10) Pub. No.: US 2018/0272261 A1
(43) Pub. Date: Sep. 27, 2018

(54) FILTER MEDIUM

(71) Applicant: Mahle International GmbH, Stuttgart (DE)

(72) Inventors: Mathias KOLLMANN, Ludmannsdorf (AT); Peter KOPPI, Sankt Margarethen (AT); Birgit RENZ, Marbach (DE); Julia TSCHISCHE, Voelkermarkt (AT)

(21) Appl. No.: 15/762,152

(22) PCT Filed: Sep. 12, 2016
(86) PCT No.: PCT/EP2016/071453

§ 371 Date: Mar. 22, 2018

(30) Foreign Application Priority Data
Sep. 22, 2015 (DE) 10 2015 218 185.5

(51) Int. Cl. B01D 39/18; B01D 39/16; B01D 39/20; B01D 17/04

(52) U.S. Cl. CPC B01D 39/18; B01D 39/16; B01D 39/2017; B01D 17/045; B01D 2239/1216; B01D 2239/0428; B01D 2239/0478; B01D 2239/065; B01D 2239/10; B01D 2239/0421

(57) ABSTRACT

A filter medium may include a hydrophilic filter layer that permits through-flow from an unfiltered side towards a clean side and a hydrophobic layer disposed on the clean side of the hydrophilic filter layer. The hydrophilic filter layer may have a pore diameter that increases in the through-flow direction. The hydrophobic layer may take the form of a film layer.

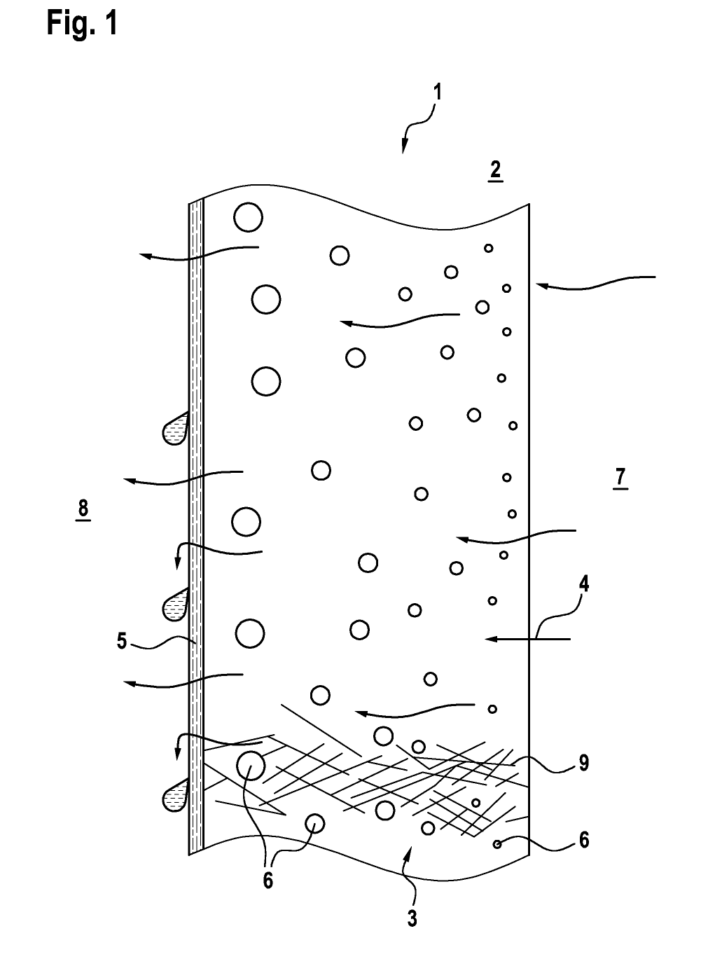

### CROSS-REFERENCE TO RELATED APPLICATION

This application claims priority to International Application No. PCT/EP2016/071453 filed on Sep. 12, 2016, and to German Application No. DE 10 2015 218 185.5 filed on Sep. 22, 2015, the contents of each of which are hereby incorporated by reference in their entirety.

### TECHNICAL FIELD

The present invention relates to a filter medium. The invention moreover relates to a liquid filter comprising such a filter medium.

### BACKGROUND

For the purpose of water separation, in particular in fuel filters, motor vehicles conventionally make use of a “coalescer” on which the aqueous components present in the fuel coalesce and can be separated in a water collecting chamber. Water separation is of particular significance here in particular for anticorrosion protection. The filter media used in coalescers are conventionally hydrophobic, such that the water fractions entrained in the fuel can be collected on a surface, coalesced into larger water droplets and then discharged, in particular under the action of gravity. In addition to such hydrophobic coalescers, there are also coalescer media which allow the water which is to be coalesced to pass through at least in part and to coalesce within the coalescer medium into larger water droplets which can then in turn be separated. Care must, however, be taken with such coalescer media to ensure that the coalesced water droplets do not emerge on a clean side of the coalescer where they are broken up again, which would negate the coalescence effect.

One drawback of hitherto known filter media for such coalescers is in particular the comparatively complex production thereof.

The present invention therefore addresses the problem of providing a filter medium which both has an increased coalescing effect and can be produced in a comparatively simple and inexpensive manner.

This problem is solved according to the invention by the subject matter of the independent claim(s). Advantageous embodiments constitute the subject matter of the dependent claims.

### SUMMARY

The present invention is based on the general concept of providing a filter medium, in particular for a coalescer, comprising a hydrophilic filter layer which permits through-flow from an unfiltered side towards a clean side, wherein the pore diameter of said layer increases in the through-flow direction. As a consequence, the pressure gradient of the filter medium declines in the through-flow direction, whereby the captured, initially small, water droplets can agglomerate as they pass through the filter medium and so form larger water drops. According to the invention, a hydrophobic layer is now applied to the clean side of the filter layer. This hydrophobic layer or the hydrophobized clean side now repels the water drops which have formed away from the filter medium, whereby said drops can then be separated either by means of gravity or for example by means of a further filter medium, for example a final separator, and for example be collected in a water collecting chamber. The filter medium embodied according to the invention may thus in particular minimize the risk known from prior filter media of water which has already coalesced into relatively large water drops no longer becoming detached from the filter medium and so being broken up on the clean side. Thanks to the simple structure according to the invention of the per se hydrophilic coalescer medium with its hydrophilic filter layer, coalescence of the water to be separated may thus proceed within the hydrophilic filter layer, wherein separation of the coalesced water proceeds simply on the clean side thanks to the hydrophobic layer applied there. The hydrophobic layer on the clean side of the filter layer may here be applied in a simple manufacturing step onto the clean side of the hydrophilic filter layer subsequent to the production of said latter layer.

In one advantageous further development of the solution according to the invention, the hydrophilic filter layer comprises cellulose, viscose material and/or hydrophilic or hydrophilized polymer or glass fibers or consists of the latter or of such a material. Cellulose is here the main constituent of plant cell walls and thus the commonest organic compound. Cellulose is additionally insoluble in water and therefore particularly suitable for use, in particular in fuel filters. Cellulose fibers may here in particular be used for the hydrophilic filter layer which may, of course, additionally be coated with further components. Additionally or alternatively, viscose may also be used in the form of semisynthetic fibers, as may also hydrophilic or hydrophilized polymer or glass fibers. It is essential for the hydrophilic fibers and layers to have a very high wetting affinity with water, in order to bind the emulsified water droplets to the fibers and to combine them into larger drops as they flow onwards through the coalescer. This effect may be enhanced by a mechanical surface treatment such as for example grinding processes on cellulose and viscose fibers which bring about a distinct increase in the functional surface. According to the invention, the hydrophobic layer here takes the form of a film layer. This means that, in comparison with the hydrophilic filter layer, the hydrophobic layer is very thin and for example merely extends in the manner of a film over the clean side of the hydrophilic filter layer.

The hydrophobic layer may here be applied for example by means of roller application, for example by fluoro chemistry, whereby merely a very thin film in the micrometer range is obtained on the clean side. In general, the coalescer is here additionally subjected to prior atmospheric pressure plasma treatment for the purpose of surface activation.

In a further advantageous embodiment of the solution according to the invention, the hydrophobic layer is applied by means of plasma treatment or is physically anchored in the surface by means of laser treatment. The per se hydrophilic surface of the hydrophilic filter layer may be modified both by plasma treatment and by laser treatment in such a manner that a hydrophobic, i.e. water-repellent, layer is obtained there. The advantage of these two methods is here that they can be used industrially, i.e. they combine high quality and low cost. One method which may, for example, be used is an atmospheric pressure plasma with nanocoating.

The present invention is further based on the general concept of equipping a liquid filter, for example a fuel filter, an oil filter or a hydraulic filter, with a filter medium as described in the preceding paragraphs. It is consequently possible to achieve a comparatively high degree of water separation with a filter medium which is comparatively simple and thus also inexpensive to manufacture.

Further important features and advantages of the invention are revealed by the subclaims, the drawing and the associated description of the FIGURE made with reference to the drawing.

It goes without saying that the above-mentioned features and those still to be explained below may be used not only in the respectively stated combination but also in other combinations or alone, without going beyond the scope of the present invention.

### BRIEF DESCRIPTION OF THE DRAWING

A preferred embodiment of the invention is illustrated in the drawing and is explained in greater detail in the following description.

The FIGURE shows a sectional representation through a filter medium according to the invention of a liquid filter.

### DETAILED DESCRIPTION

According to the FIGURE, a filter medium 1 according to the invention, which can be used in a liquid filter 2, in particular in a fuel filter, an oil filter or a hydraulic filter, comprises a hydrophilic filter layer 3 and, subsequent thereto in the direction of flow 4, a hydrophobic layer 5. In the example shown in the FIGURE, the fluid to be purified, for example the fuel, thus flows through the filter medium 1 from right to left. A pore diameter of the individual pores 6 here increases in the through-flow direction 4, whereby a pressure gradient in the filter medium 1 declines in the direction of flow 4. In the present case, the pore size thus increases from an unfiltered side 7 towards a clean side 8 of the filter medium 1.

The hydrophilic filter layer 3 may for example comprise cellulose, viscose material and/or hydrophilic or hydrophilized polymer or glass fibers 9 or consist of such a material or such fibers 9. It is, of course, also conceivable for the filter layer 3 to consist of cellulose fibers or of viscose fibers or to comprise such fibers 9.

The hydrophobic layer 5 may here take the form of a film layer and therefore have a distinctly smaller thickness in comparison with the hydrophilic filter layer 3. The hydrophobic layer 5 may for example be applied by means of roller application, by means of plasma treatment and/or by means of laser treatment. The surface of the filter layer 3 may, for example, be activated by means of a plasma treatment, whereupon the hydrophobic layer 5 may for example then be applied by means of roller application. An “atmospheric pressure plasma method” may here be used, in which the pressure roughly corresponds to that of the surrounding atmosphere, i.e. conventionally to “standard” pressure. Partial surface removal may also be achieved by means of laser treatment, for example in order to achieve a “lotus effect”.

Using the filter medium 1 according to the invention, it is possible to achieve a simple structure of a per se hydrophilic coalescer medium with a pressure gradient which declines from an unfiltered side 7 to the clean side 8 by a simple post-treatment of the clean side 8 of the filter medium 1 involving subsequent application of the hydrophobic layer 5 to the clean side 8. This assists with more readily detaching the water drops 10 which have coalesced in the filter medium 1 from the filter medium 1 and so in particular prevents the water drops 10 from breaking up which, under certain circumstances, could negate the coalescing effect.

Using the filter medium 1 according to the invention, it is in particular simply possible to retrofit ordinary liquid filters, such as for example fuel filters, oil filters or hydraulic filters, and comparatively inexpensively achieve a high degree of water separation.

1. A filter medium comprising:
a hydrophilic filter layer that permits through-flow from an unfiltered side towards a clean side, the hydrophilic filter layer having a pore diameter that increases in the through-flow direction;
a hydrophobic layer disposed on the clean side of the hydrophilic filter layer; and
wherein the hydrophobic layer is a film layer.

2. The filter medium as claimed in claim 1, the hydrophilic filter layer is composed of at least one of a cellulose material, a viscose material, a hydrophilic polymer, a hydrophilized polymer, and glass fibers.

3. The filter medium as claimed in claim 1, wherein the hydrophobic layer is coupled to the clean side of the hydrophilic filter layer via a roller application.

4. The filter medium as claimed in claim 1, wherein the hydrophobic layer is coupled to the clean side of the hydrophilic filter layer via a plasma treatment.

5. The filter medium as claimed in claim 1, wherein the hydrophobic layer is coupled to the clean side of the hydrophilic filter layer via a laser treatment.

6. A liquid filter, comprising:
a filter medium, including:
a hydrophilic filter layer that permits through-flow from an unfiltered side towards a clean side, the hydrophilic filter layer having a pore diameter that increases in the through-flow direction;
a hydrophobic layer disposed on the clean side of the hydrophilic filter layer; and
wherein the hydrophobic layer is a film layer.

7. The liquid filter as claimed in claim 6, wherein the filter medium is a fuel filter medium, an oil filter medium, or a hydraulic filter medium.

8. The liquid filter as claimed in claim 6, wherein the hydrophobic layer has a thickness smaller than that of the hydrophilic filter layer.

9. The liquid filter as claimed in claim 6, wherein the hydrophilic filter layer has a plasma activated surface.

10. The liquid filter as claimed in claim 6, wherein the hydrophilic filter layer has a laser activated surface.

11. The liquid filter as claimed in claim 6, wherein the hydrophobic layer is physically anchored in a surface of the hydrophilic filter layer via a laser bonded connection.

12. The liquid filter as claimed in claim 6, wherein the hydrophilic filter layer is composed of a cellulose material.

13. The liquid filter as claimed in claim 6, wherein the hydrophilic filter layer is composed of a viscose material.

14. The liquid filter as claimed in claim 6, wherein the hydrophilic filter layer is composed of a hydrophilic polymer.

15. The liquid filter as claimed in claim 6, wherein the hydrophilic filter layer is composed of a hydrophilized polymer.

16. The liquid filter as claimed in claim 6, wherein the hydrophilic filter layer is composed of a material including glass fibers.

17. The filter medium as claimed in claim 1, wherein the hydrophilic filter layer has a plasma activated surface.

18. The filter medium as claimed in claim 1, wherein the hydrophilic filter layer has a laser activated surface.

19. The filter medium as claimed in claim 1, wherein the hydrophobic layer has a thickness smaller than that of the hydrophilic filter layer.

20. A filter medium, comprising:
a hydrophilic filter layer that permits through-flow from an unfiltered side towards a clean side, the hydrophilic filter layer having a pore diameter that increases in the through-flow direction;
a hydrophobic layer disposed on the clean side of the hydrophilic filter layer, wherein the hydrophobic layer is a film layer; and
wherein the hydrophilic filter layer has at least one of a plasma activated surface and a laser activated surface.
